(19) United States
(12) Patent Application Publication
(10) Pub. No.: US 2019/0210222 A1
(43) Pub. Date: Jul. 11, 2019

(54) APPARATUS AND METHOD FOR CONTROLLING ROBOT

(71) Applicant: ABB Schweiz AG, Baden (CH)

(72) Inventor: Jun Li, Shanghai (CN)

(21) Appl. No.: 16/299,257

(22) Filed: Mar. 12, 2019

Related U.S. Application Data
(63) Continuation of application No. PCT/CN2016/101902, filed on Oct. 12, 2016.

(51) Int. Cl. B25J 9/16; G05B 19/05

(52) U.S. Cl. CPC B25J 9/1658; G05B 2219/23289; G05B 19/05; B25J 9/1692

(57) ABSTRACT

An apparatus for controlling a robot includes a programmable logic controller (PLC) configured to define, based on a finite state machine (FSM): states and associated operations of the robot, and switching conditions among the states, wherein the robot is switched among different states in response to a switching condition being satisfied. The FSM at least includes an initial state for a self-test procedure to check whether components of the robot are able to operate properly, and a calibration state for calibrating the robot. And a method for controlling a robot. The use of PLC programming language facilitates an easy programming and maintenance of the whole robot system.

### FIELD

Embodiments of present disclosure generally relates to a control apparatus, and more particularly, to an apparatus for controlling a robot and a method for controlling the same.

### BACKGROUND

Programmable logic controller (PLC) has been widely utilized in the control of industrial processes or machines, such as assembly lines and robotic devices. Modern PLCs can be programmed by using PLC programming languages. Among various PLC programming languages, a high-level one is designed to program PLCs based on a finite state machine (FSM). Such FSM-based PLC programming language is easy-to-understand, especially for the programmers of equipment manufacturers, which in turn reduces the training demand and thereby facilitates an easy maintenance for the controlling system.

A series of standardized tools for the motion control have been proposed by the PLC-Open group to reduce the programming complexity. However, none of those proposed standard tools or FSMs aims at the robot control, especially the industrial robot control. Therefore, it is always desirable to create a robot-specific standard rules or FSM design which can achieve a more perfect movement control of a robot with an improved user's usability.

### SUMMARY

In first aspect of present disclosure, an apparatus for controlling a robot is provided. The apparatus for controlling a robot comprises a programmable logic controller (PLC) configured to define, based on a finite state machine (FSM): states and associated operations of the robot, and switching conditions among the states, wherein the robot is switched among different states in response to a switching condition being satisfied, wherein the FSM at least includes: an initial state for a self-test procedure to check whether components of the robot are able to operate properly, and a calibration state for calibrating the robot.

In some embodiments, the PLC is further configured to: initialize the robot, in the initial state, to enable the self-test procedure; and in response to determining that the self-test procedure is successful, transit the robot from the initial state to the calibration state.

In some embodiments, the PLC is further configured to: while the robot is in the calibration state, in response to determining that the calibration is done, transit the robot from the calibration state to a disabled state in which the robot is powered down.

In some embodiments, the PLC further configured to: while the robot is in the disabled state, in response to receiving an coordinate-defining instruction, keep the robot in the disabled state and activate the robot to facilitate a definition of a coordinate system for the robot; and in response to receiving a calibration instruction, transit the robot from the disabled state back to the calibration state.

In some embodiments, the activating the robot to facilitate the definition of the coordinate system for the robot includes performing at least one of: defining work object data, payload data, tool data, work object coordinate or a user frame; reading work object data, payload data or tool data; calibrating a base frame or a user frame; and identifying a position of a target and informing the position to the PLC.

In some embodiments, the PLC is further configured to: while the robot is in the disabled state, in response to receiving an enable instruction, transit the robot from the disabled state to a standby state in which the robot is powered up and axes of the robot are held at corresponding current positions.

In some embodiments, the PLC is further configured to: while the robot is in the standby state, in response to receiving a jogging instruction, transit the robot from the standby state to a moving state to activate the robot to jog; and while the robot is in the moving state, in response to receiving a jogging instruction, keep the robot in the moving state and activate the robot to jog.

In some embodiments, the PLC is further configured to: while the robot is in the moving state, in response to receiving a stopping instruction, transit the robot from the moving state to a stopping state to stop a movement of the robot.

In some embodiments, the stopping instruction includes: a first stopping instruction configured to stop the movement of the robot in response to an error being detected; a second stopping instruction configured to stop the movement of the robot meanwhile disconnecting power supply to the robot; and a third stopping instruction configured to stop the movement of the robot meanwhile maintaining the power supply to the robot.

In some embodiments, the PLC further configured to: in response to receiving the first stopping instruction, further transit the robot from the stopping state to an error state; in response to receiving the second stopping instruction, further transit the robot from the stopping state back to the disabled state; and in response to receiving the third stopping instruction, further transit the robot from the stopping state back to the standby state.

In some embodiments, the PLC further configured to: while the robot is in the error state, in response to receiving a reset instruction, transit the robot from the error state to the initial state; and in response to receiving an error-clearing instruction, transit the robot from the error state to the disabled state.

In second aspect of present disclosure, a method for controlling a robot is provided. The method comprises defining, based on a FSM in a PLC: states and associated operations of the robot, and switching conditions among the states; and switching the robot among different states in response to a switching condition being satisfied, wherein the FSM at least includes: an initial state for a self-test procedure to check whether components of the robot are able to operate properly, and a calibration state for calibrating the robot.

In some embodiments, switching the robot among different states comprises: initializing the robot, in the initial state, to enable the self-test procedure; and in response to determining that the self-test procedure is successful, transiting the robot from the initial state to the calibration state.

In some embodiments, switching the robot among different states further comprises: while the robot is in the calibration state, in response to determining that the calibration is done, transiting the robot from the calibration state to a disabled state in which the robot is powered down.

In some embodiments, switching the robot among different states further comprises: while the robot is in the disabled state, in response to receiving an coordinate-defining instruction, keeping the robot in the disabled state and activating the robot to facilitate a definition of a coordinate system for the robot; and in response to receiving a calibration instruction, transiting the robot from the disabled state back to the calibration state.

In some embodiments, the activating the robot to facilitate the definition of the coordinate system for the robot includes performing at least one of: defining work object data, payload data, tool data, work object coordinate or a user frame; reading work object data, payload data or tool data; calibrating a base frame or a user frame; and identifying a position of a target and informing the position to the PLC.

In some embodiments, switching the robot among different states further comprises: while the robot is in the disabled state, in response to receiving an enable instruction, transiting the robot from the disabled state to a standby state in which the robot is powered up and axes of the robot are held at corresponding current positions.

In some embodiments, switching the robot among different states further comprises: while the robot is in the standby state, in response to receiving a jogging instruction, transiting the robot from the standby state to a moving state to activate the robot to jog; and while the robot is in the moving state, in response to receiving a jogging instruction, keeping the robot in the moving state and activating the robot to jog.

In some embodiments, switching the robot among different states further comprises: while the robot is in the moving state, in response to receiving a stopping instruction, transiting the robot from the moving state to a stopping state to stop a movement of the robot.

In some embodiments, the stopping instruction includes: a first stopping instruction configured to stop the movement of the robot in response to an error being detected; a second stopping instruction configured to stop the movement of the robot meanwhile disconnecting power supply to the robot; and a third stopping instruction configured to stop the movement of the robot meanwhile maintaining the power supply to the robot.

In some embodiments, switching the robot among different states further comprises: in response to receiving the first stopping instruction, further transiting the robot from the stopping state to an error state; in response to receiving the second stopping instruction, further transiting the robot from the stopping state back to the disabled state; and in response to receiving the third stopping instruction, further transiting the robot from the stopping state back to the standby state.

In some embodiments, switching the robot among different states further comprises: while the robot is in the error state, in response to receiving a reset instruction, transiting the robot from the error state to the initial state; and in response to receiving an error-clearing instruction, transiting the robot from the error state to the disabled state.

In third aspect of present disclosure, a robot comprising the apparatus according to the first aspect of present disclosure is provided.

In fourth aspect of present disclosure, a device is provided. The device comprises: a processing unit; and a memory coupled to the processing unit and storing instructions thereon, the instructions, when executed by the processing unit, causing the device to perform the method according to the second aspect of present disclosure.

According to various embodiments of present disclosure, the apparatus for controlling the robot provides a new solution for PLC-based robot movement. Such PLC-based robot control scheme along with properly designed function blocks defined/programmed via PLC programming language not only makes up the lack of robot-specific movement control in the PLC-Open, but also specifies a standard rule for the robot control software. Meanwhile, the use of PLC programming language facilitates an easy programming and maintenance of the whole robot system.

### DESCRIPTION OF DRAWINGS

Drawings described herein are provided to further explain the present disclosure and constitute a part of the present application. The example embodiments of the disclosure and the explanation thereof are used to explain the present disclosure, rather than to limit the present disclosure improperly.

FIG. 1 is a block diagram of an apparatus for controlling a robot according to embodiments of the present disclosure.

FIG. 2 is a FSM used for controlling a robot according to embodiments of the present disclosure.

FIG. 3 is a flow chart of a method for controlling a robot according to embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

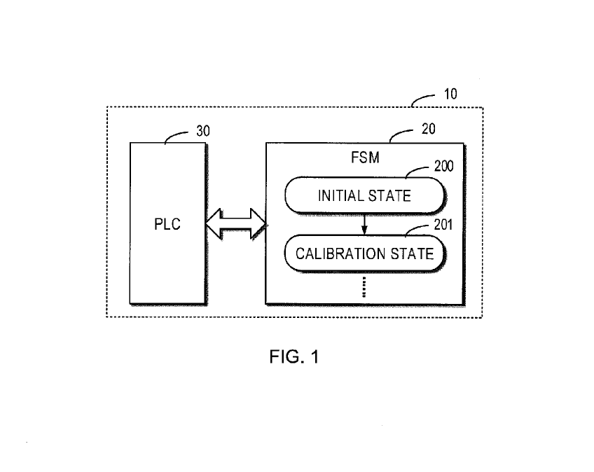

FIG. 1 illustrates a block diagram of an apparatus 10 for controlling a robot according to embodiments of the present disclosure. As shown in FIG. 1, the apparatus 10 includes a programmable logic controller (PLC) 30 The PLC 30 is configured to define, based on a finite state machine (FSM) 20, states and associated operations of the robot, and switching conditions among the states. Thereby, the robot can be switched among different states if a switching condition is satisfied.

The FSM 20 as depicted in FIG. 1 includes at least two new states, namely, an initial state 200 and a calibration state 201. The initial state 200 is added to enable a self-test procedure to check whether components of the robot are able to operate properly, and the calibration state 201 is configured for calibrating the robot. These two states can be quite useful. For example, if the robot cannot start for some reason, the initial state 200 may give the user a signal containing important messages and thereby facilitate the trouble shooting or maintenance of the robot system. Further, the calibration state 201 may additionally check if the robot has been calibrated or not. With those two newly introduced states and other states (not particularly shown in FIG. 1) as well as associated switching conditions and function blocks (which will be further discussed in details), such robot-specific FSM design would allow an improved robot movement control.

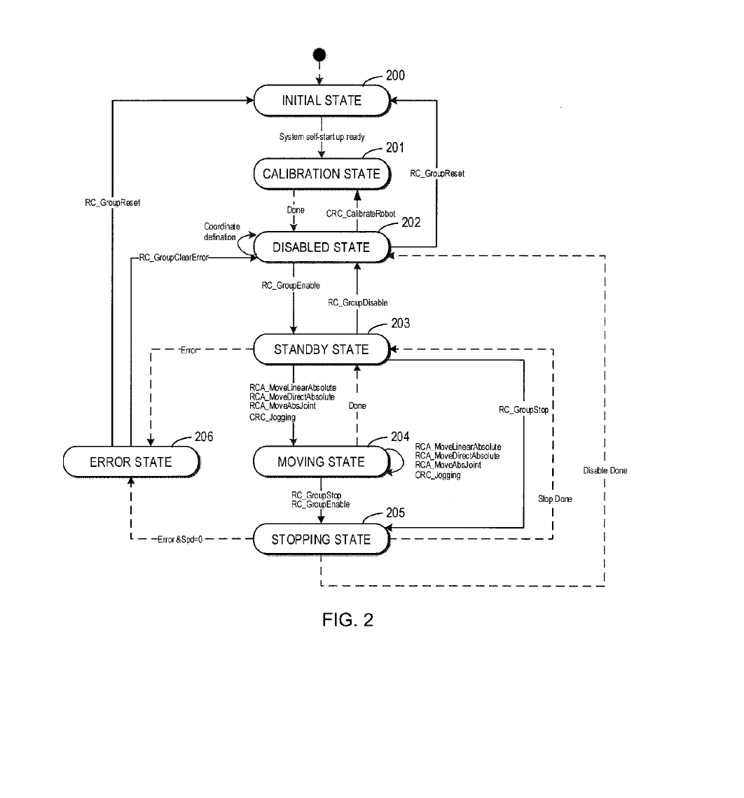

FIG. 2 illustrates an example FSM 20 for the robot according to an embodiment of present disclosure. As shown in FIG. 2, in addition to the initial state 200 and the calibration state 201 as depicted in FIG. 1, the FSM 20 of FIG. 2 further includes several other states including a disabled state 202, a standby state 203, a moving state 204, a stopping state 205, and an error state 206. As discussed above, if a specific switching condition is satisfied, the robot will be switched among different states within the FSM 20, accordingly.

In the embodiment as depicted in FIG. 2, the initial state 200 is a starting state of the FSM 20. In the initial state 200, the PLC 30 is configured to initialize the robot to enable the self-test procedure. Further, if the self-test procedure is determined to be successful, or in other words, the self-startup of the robot is ready, the PLC 30 is configured to transit the robot from the initial state 200 to the calibration state 201.

While the robot is in the calibration state 201, and if the calibration is determined to be done (labeled by “Done”), the PLC 30 is further configured to transit the robot from the calibration state 201 to a disabled state 202. It is noted that the robot is powered down, for example, not powered up yet in the disabled state 202.

While the robot is in the disabled state 202, if a coordinate-defining instruction (labeled by “Coordinate Definition”) is received, the PLC 30 is further configured to keep the robot in the disabled stale 202 and activate the robot to facilitate a definition of a coordinate system for the robot system. On the other hand, if a calibration instruction (labeled by “CRC_CalibrateRobot”) is received, the PLC 30 is further configured to transit the robot from the disabled state 202 back to the calibration state 201.

In some embodiments, activating the robot to facilitate the definition of the coordinate system for the robot includes performing at least one of the following operations: defining work object data, payload data, tool data, work object coordinate or a user frame; reading work object data, payload data or tool data; calibrating a base frame or a user frame; and identifying a position of a target and informing the position to the PLC 30.

Since an accurate definition of a coordinate system is usually essential for most of the robot systems, especially for the industrial robot, such properly designed coordinate-defining operations as described could be very useful, which will in turn lead to a more perfect robot control.

In some embodiments, it is possible to achieve the improved operations as described above for facilitating the definition of the coordinate system by directly calling well-defined function blocks. Table 1, as an example, shows some function blocks with detailed descriptions according to various embodiments of present disclosure. With those specific and properly defined function blocks, any user who is familiar with PLC programming language can control the robot more easily.

TABLE 1

| Name | Description |
|---|---|
| CRC_DefineWobj | defining work object data in the work |
| | object table |
| CRC_DefinePayload | defining one work object data |
| CRC_DefineTool | defining one tool data |
| CRC_ReadWobj | reading work object data |
| CRC_ReadPayload | reading payload data in the payload table |
| CRC_ReadTool | reading tool data in the tool table |
| CRC_Jogging | commanding a jogged movement in six |
| | degree of freedom |
| CRC_CalibrateBaseFrame | calibrating the base frame, wherein four |
| | point-X, Z method can be used to do the |
| | calibration |
| CRC_TeachObjFrame | defining the work object coordination |
| | system by 3-point method |
| CRC_TeachTarget | identifying a position of a target and letting |
| | the controller know the target position in the |
| | working process |
| CRC_TeachToolFrame | calibrating the tool frame by four point-XZ |
| | method |
| CRC_TeachUserFrame | defining user frame by three point method |
| CRC_CalibrateRobot | Calibrating the robot |

Still in reference to FIG. 2, while the robot is in the disabled state 202, and if an enable instruction is received (labeled by “RC_GroupEnable”), the PLC 30 is further configured to transit the robot from the disabled state 202 to a standby state 203. In the standby state 203, the robot is powered up but all axes of the robot are held at their corresponding current positions.

In the embodiment as depicted in FIG. 2, while the robot is in the disabled state 202, if an reset instruction is received (labeled by “RC_GroupReset”), the PLC 30 may additionally be configured to transit the robot from the disabled state 202 directly back to the initial state 200.

Continuing to refer to FIG. 2, while the robot is in the standby state 203, if a jogging instruction is received (labeled by “CRC_Jogging”), the PLC 30 is further configured to transit the robot from the standby state 203 to a moving state 204 to activate the robot to jog. Alternatively or additionally, if other moving instructions, such as linear moving instruction are received (labeled by “RCA_MoveLinearAbsolute”), the PLC 30 may also be configured to transit the robot from the standby state 203 to a moving state 204 to activate the robot, but to perform a corresponding movement.

In some embodiments, while the robot is in the standby state 203, if a disable instruction is received (labeled by “RC_GroupDisable”), the PLC 30 may be configured to transit the robot from the standby state 203 back to the disabled state 202.

In the embodiment as depicted in FIG. 2, while the robot is in the moving state 204, if a jogging instruction is received, the PLC 30 is further configured to keep the robot in the moving state 204 and activate the robot to jog. Other moving instruction also applies in a similar manner. In some embodiments, upon any movement is done (labeled by “Done”), the PLC 30 is further configured to transit the robot from the moving state 204 back to the standby state 203.

Continuing to refer to FIG. 2, while the robot is in the moving state 204, if a stopping instruction is received (labeled by “RC_GroupStop and RC_GroupEnable”), the PLC 30 is further configured to transit the robot from the moving state 204 to a stopping state 205 to stop any movement of the robot. In some embodiments, while the robot is in the standby state 203, if a stopping instruction is received (also labeled by “RC_GroupStop”), the PLC 30 may also configured to transit the robot from the standby state 203 directly to a stopping state 205 to stop any movement of the robot.

In some embodiments, such stopping instructions may further be categorized into different types. For example, the stopping instruction may include a first stopping instruction that is configured to stop the movement of the robot if an error is detected. The stopping instruction may also include a second stopping instruction that is configured to stop the movement of the robot meanwhile disconnecting power supply to the robot (or powered down) as needed. Further, the stopping instruction may include a third stopping instruction that is configured to stop the movement of the robot meanwhile maintaining the power supply to the robot as needed.

Depending on the specific type of stopping instruction that is received, the state transition from the stopping state 205 would vary accordingly. For example, if the first stopping instruction along with a speed of zero is received (labeled by “Error& Spd=0”), the PLC 30 is configured to further transit the robot from the stopping state 205 to an error state 206 automatically. It is noted that all automatic transitions depicted in FIG. 2 are represented by dotted lines. In some embodiments, the PLC 30 may also be configured to transit the robot in the standby state 203 directly to the error state 206, if an error message is received (labeled by “Error”).

On the other hand, while the robot is in the stopping state 205, if the second stopping instruction is received and upon the disable being done (labeled by “Disable Done”), the PLC 30 is configured to further transit the robot from the stopping state 205 back to the disabled state 202. Further, if the third stopping instruction is received and upon the stop being done (labeled by “Stop Done”), the PLC 30 is configured to further transit the robot from the stopping state 205 back to the standby state 203.

Continuing to refer to FIG. 2, while the robot is in the error state 206, if a reset instruction is received (labeled by “RC_GroupReset”), the PLC 30 is further configured to directly transit the robot from the error state 206 back to the initial state 200. On the other hand, if an error-clearing instruction is received (labeled by “RC_GroupClearError”), the PLC 30 is further configured to transit the robot from the error state 206 to the disabled state 202.

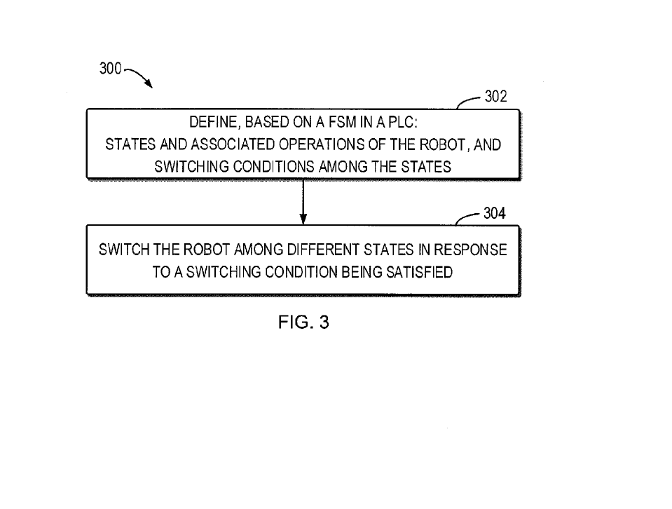

FIG. 3 illustrates a flow chart of a method for controlling a robot according to embodiments of the present disclosure. The method 300 can be carried out by, for example the apparatus 10 as illustrated in FIG. 1. As shown, at 302, states and associated operations of the robot as well as switching conditions among the states are defined based on a FSM 20 in a PLC 30. At 304, the robot is switched among different states if a switching condition is satisfied. As described above, the FSM 20 used in method 300 at least includes an initial state 200 for a self-test procedure to check whether components of the robot are able to operate properly and a calibration state 201 for calibrating the robot.

In some embodiments, switching the robot among different states includes initializing the robot, in the initial state 200, to enable the self-test procedure. The state switching also includes if the self-test procedure is determined to be successful, transiting the robot from the initial state 200 to the calibration state 201.

In some embodiments, switching the robot among different states further includes while the robot is in the calibration state 201, if the calibration is determined to be done, transiting the robot from the calibration state 201 to a disabled state 202 in which the robot is powered down.

In some embodiments, switching the robot among different states further includes while the robot is in the disabled state 202, if a coordinate-defining instruction is received, keeping the robot in the disabled state 202 and activating the robot to facilitate a definition of a coordinate system for the robot. The state switching also includes if a calibration instruction is received, transiting the robot from the disabled state 202 back to the calibration state 201.

In some embodiments, the activating the robot to facilitate the definition of the coordinate system for the robot includes performing at least one of the following operations: defining work object data, payload data, tool data, work object coordinate or a user frame; reading work object data, payload data or tool data; calibrating a base frame or a user frame; and identifying a position of a target and informing the position to the PLC 30.

In some embodiments, switching the robot among different states further includes while the robot is in the disabled state 202, if an enable instruction is received, transiting the robot from the disabled state 202 to a standby state 203 in which the robot is powered up and axes of the robot are held at corresponding current positions.

In some embodiments, switching the robot among different states further includes while the robot is in the standby state 203, if a jogging instruction is received, transiting the robot from the standby state 203 to a moving state 204 to activate the robot to jog. The state switching also includes while the robot is in the moving state 204, if a jogging instruction is received, keeping the robot in the moving state 204 and activating the robot to jog.

In some embodiments, switching the robot among different states further includes while the robot is in the moving state 204, if a stopping instruction is received, transiting the robot from the moving state 204 to a stopping state 205 to stop a movement of the robot.

In some embodiments, the stopping instruction includes a first stopping instruction, a second stopping instruction, and a third stopping instruction. The first stopping instruction is configured to stop the movement of the robot if an error is detected, the second stopping instruction is configured to stop the movement of the robot meanwhile disconnecting power supply to the robot, and the third stopping instruction is configured to stop the movement of the robot meanwhile maintaining the power supply to the robot.

In some embodiments, switching the robot among different states further includes if the first stopping instruction is received, further transiting the robot from the stopping state 205 to an error state 206. The state switching also includes if the second stopping instruction is received, further transiting the robot from the stopping state 205 back to the disabled state 202. The state switching also includes if the third stopping instruction is received, further transiting the robot from the stopping state 205 back to the standby state 203.

In some embodiments, switching the robot among different states further includes while the robot is in the error state 206, if a reset instruction is received, transiting the robot from the error state 206 to the initial state 200. The state switching also includes if an error-clearing instruction is received, transiting the robot from the error state 206 to the disabled state 202.

The subject matter described herein may be embodied as a device comprising a processing unit and a memory. The memory is coupled to the processing unit and stores instructions for execution by the processing unit. The instructions, when executed by the processing unit, cause the device to defining, based on a FSM 20 in a PLC 30: states and associated operations of the robot, and switching conditions among the states. The instructions further cause the device to switching the robot among different states if a switching condition is satisfied. The FSM 20 at least includes: an initial state 200 for a self-test procedure to check whether components of the robot are able to operate properly, and a calibration state 201 for calibrating the robot.

Instructions stored in the memory, for example, may be any of instructions or function blocks as discussed above, such as CRC_DefineWob, CRC_DefinePayload, CRC_DefineTool, CRC_ReadWobj, CRC_ReadPayload, CRC_ReadTool, CRC_Jogging, CRC_CalibrateBaseFrame, CRC_TeachObjFrame, CRC_TeachTarget CRC_TeachToolFrame, CRC_TeachUserFrame, and CRC_CalibrateRobot.

In the context of the subject matter described herein, a memory may be any tangible medium that can contain, or store a program for use by or in connection with an instruction execution system, apparatus, or device. The memory may be a machine readable signal medium or a machine readable storage medium. A memory may include but not limited to an electronic, magnetic, optical, electromagnetic, infrared, or semiconductor system, apparatus, or device, or any suitable combination of the foregoing. More specific examples of the memory would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

1. An apparatus for controlling a robot, comprising:
a programmable logic controller (PLC) configured to define, based on a finite state machine (FSM):
states and associated operations of the robot, and
switching conditions among the states, wherein the robot is switched among different states in response to a switching condition being satisfied,
wherein the FSM at least includes:
an initial state for a self-test procedure to check whether components of the robot are able to operate properly, and
a calibration state for calibrating the robot.

2. The apparatus according to claim 1, wherein the PLC is further configured to:
initialize the robot, in the initial state, to enable the self-test procedure; and
in response to determining that the self-test procedure is successful, transit the robot from the initial state to the calibration state.

3. The apparatus according to claim 2, wherein the PLC is further configured to:
while the robot is in the calibration state, in response to determining that the calibration is done, transit the robot from the calibration state to a disabled state in which the robot is powered down.

4. The apparatus according to claim 3, wherein the PLC is further configured to:
while the robot is in the disabled state,
in response to receiving an coordinate-defining instruction, keep the robot in the disabled state and activate the robot to facilitate a definition of a coordinate system for the robot; and
in response to receiving a calibration instruction, transit the robot from the disabled state back to the calibration state.

5. The apparatus according to claim 4, wherein the activating the robot to facilitate the definition of the coordinate system for the robot includes performing at least one of:
defining work object data, payload data, tool data, work object coordinate or a user frame;
reading work object data, payload data or tool data;
calibrating a base frame or a user frame; and
identifying a position of a target and informing the position to the PLC.

6. The apparatus according to claim 3, wherein the PLC is further configured to:
while the robot is in the disabled state, in response to receiving an enable instructions, transit the robot from the disabled state to a standby state in which the robot is powered up and axes of the robot are held at corresponding current positions.

7. The apparatus according to claim 6, wherein the PLC is further configured to:
while the robot is in the standby state, in response to receiving a jogging instruction, transit the robot from the standby state to a moving state to activate the robot to jog; and
while the robot is in the moving state, in response to receiving a jogging instruction, keep the robot in the moving state and activate the robot to jog.

8. The apparatus according to claim 7, wherein the PLC is further configured to:
while the robot is in the moving state, in response to receiving a stopping instruction, transit the robot from the moving state to a stopping state to stop a movement of the robot.

9. The apparatus according to claim 8, wherein the stopping instruction includes:
a first stopping instruction configured to stop the movement of the robot in response to an error being detected;
a second stopping instruction configured to stop the movement of the robot meanwhile disconnecting power supply to the robot; and
a third stopping instruction configured to stop the movement of the robot meanwhile maintaining the power supply to the robot.

10. The apparatus according to claim 9, wherein the PLC is further configured to:
in response to receiving the first stopping instruction, further transit the robot from the stopping state to an error state;
in response to receiving the second stopping instruction, further transit the robot from the stopping state back to the disabled state; and
in response to receiving the third stopping instruction, further transit the robot from the stopping state back to the standby state.

11. The apparatus according to claim 10, wherein the PLC is further configured to:
while the robot is in the error state,
in response to receiving a reset instruction, transit the robot from the error state to the initial state; and
in response to receiving an error-clearing instruction, transit the robot from the error state to the disabled state.

12. A method for controlling a robot, comprising:
defining, based on a finite state machine (FSM) in a programmable logic controller (PLC):
states and associated operations of the robot, and
switching conditions among the states; and
switching the robot among different states in response to a switching condition being satisfied,
wherein the FSM at least includes:
an initial state for a self-test procedure to check whether components of the robot are able to operate properly, and
a calibration state for calibrating the robot.

13. The method according to claim 12, wherein switching the robot among different states comprises:
initializing the robot, in the initial state, to enable the self-test procedure; and
in response to determining that the self-test procedure is successful, transiting the robot from the initial state to the calibration state.

14. The method according to claim 13, wherein switching the robot among different states further comprises:
while the robot is in the calibration state, in response to determining that the calibration is done, transiting the robot from the calibration state to a disabled state in which the robot is powered down.

15. The method according to claim 14, wherein switching the robot among different states further comprises:
while the robot is in the disabled state,
in response to receiving an coordinate-defining instruction, keeping the robot in the disabled state and activating the robot to facilitate a definition of a coordinate system for the robot; and
in response to receiving a calibration instruction, transiting the robot from the disabled state back to the calibration state.

16. The method according to claim 15, wherein the activating the robot to facilitate the definition of the coordinate system for the robot includes performing at least one of:
defining work object data, payload data, tool data, work object coordinate or a user frame;
reading work object data, payload data or tool data;
calibrating a base frame or a user frame; and
identifying a position of a target and informing the position to the PLC.

17. The method according to claim 14, wherein switching the robot among different states further comprises:
while the robot is in the disabled state, in response to receiving an enable instruction, transiting the robot from the disabled state to a standby state in which the robot is powered up and axes of the robot are held at corresponding current positions.

18. The method according to claim 17, wherein switching the robot among different states further comprises:
while the robot is in the standby state, in response to receiving a jogging instruction, transiting the robot from the standby state to a moving state to activate the robot to jog; and
while the robot is in the moving state, in response to receiving a jogging instruction, keeping the robot in the moving state and activating the robot to jog.

19. The method according to claim 18, wherein switching the robot among different states further comprises:
while the robot is in the moving state, in response to receiving a stopping instruction, transiting the robot from the moving state to a stopping state to stop a movement of the robot.

20. The method according to claim 19, wherein the stopping instruction includes:
a first stopping instruction configured to stop the movement of the robot in response to an error being detected;
a second stopping instruction configured to stop the movement of the robot meanwhile disconnecting power supply to the robot; and
a third stopping instruction configured to stop the movement of the robot meanwhile maintaining the power supply to the robot.

21. The method according to claim 20, wherein switching the robot among different states further comprises:
in response to receiving the first stopping instruction, further transiting the robot from the stopping state to an error state;
in response to receiving the second stopping instruction, further transiting the robot from the stopping state back to the disabled state; and
in response to receiving the third stopping instruction, further transiting the robot from the stopping state back to the standby state.

22. The method according to claim 21, wherein switching the robot among different states further comprises:
while the robot is in the error state,
in response to receiving a reset instruction, transiting the robot from the error state to the initial state; and
in response to receiving an error-clearing instruction, transiting the robot from the error state to the disabled state.

23. A robot comprising the apparatus according to claim 1.

24. A robot comprising:
a processing unit; and
a memory coupled to the processing unit and storing instructions thereon, the instructions, when executed by the processing unit, causing the device to define, based on a finite state machine (FSM):
states and associated operations of the robot, and
switch conditions among the states; and
switch the robot among different states in response to a switching condition being satisfied,
wherein the FSM at least includes:
an initial state for a self-test procedure to check whether components of the robot are able to operate properly, and
a calibration state for calibrating the robot.
